(19) United States
(12) Patent Application Publication
(10) Pub. No.: US 2016/0224203 A1
(43) Pub. Date: Aug. 4, 2016

(54) USING A PERPENDICULAR BISECTOR OF A MULTI-FINGER GESTURE TO CONTROL MOTION OF OBJECTS SHOWN IN A MULTI-DIMENSIONAL ENVIRONMENT ON A DISPLAY

(71) Applicant: CIRQUE CORPORATION, Salt Lake City, UT (US)

(72) Inventor: David C. Taylor, West Jordan, UT (US)

(21) Appl. No.: 15/013,691

(22) Filed: Feb. 2, 2016

Related U.S. Application Data
(60) Provisional application No. 62/110,891, filed on Feb. 2, 2015.

(51) Int. Cl. G06F 3/0481; G06F 3/0484; G06F 3/0354; G06F 3/0488

(52) U.S. Cl. CPC G06F 3/04815; G06F 3/04883; G06F 3/04845; G06F 3/0354; G06F 2203/04104

(57) ABSTRACT

A system and method for providing control of an object within a multi-dimensional environment that is being shown on a computer display, wherein two objects such as fingers define two points of contact on a touch sensor, a line being defined between the two points, a center point on the line between the two fingers being calculated and defined as a pivot point, and a perpendicular bisector of the line and that passes through the pivot point may be used to define a forward facing direction of an object within the multi-dimensional environment that is shown on the display screen, wherein the pivot point may be defined as being at a center or at a front facing point of the object

### BACKGROUND OF THE INVENTION

1. Field of the Invention

This invention relates generally to multi-finger gestures on touch sensors. Specifically, the invention pertains to a multi-finger gesture that may define a line between two objects on a touch sensor, the line also defining a perpendicular bisector and a direction, the motion of the two fingers and the direction being used to control movement or motion of an object in a multi-dimensional environment that is shown on a display.

2. Description of Related Art

There are several designs for capacitance sensitive touch sensors which may take advantage of the multi-finger gesture. It is useful to examine some of the underlying technology of the touch sensors to better understand how any capacitance sensitive touchpad can take advantage of the present invention.

The CIRQUE® Corporation touchpad is a mutual capacitance-sensing device and an example is illustrated as a block diagram in FIG. 1. In this touchpad 10, a grid of X (12) and Y (14) electrodes and a sense electrode 16 is used to define the touch-sensitive area 18 of the touchpad. Typically, the touchpad 10 is a rectangular grid of approximately 16 by 12 electrodes, or 8 by 6 electrodes when there are space constraints. Interlaced with these X (12) and Y (14) (or row and column) electrodes is a single sense electrode 16. All position measurements are made through the sense electrode 16.

The CIRQUE® Corporation touchpad 10 measures an imbalance in electrical charge on the sense line 16. When no pointing object is on or in proximity to the touchpad 10, the touchpad circuitry 20 is in a balanced state, and there is no charge imbalance on the sense line 16. When a pointing object creates imbalance because of capacitive coupling when the object approaches or touches a touch surface (the sensing area 18 of the touchpad 10), a change in capacitance occurs on the electrodes 12, 14. What is measured is the change in capacitance, but not the absolute capacitance value on the electrodes 12, 14. The touchpad 10 determines the change in capacitance by measuring the amount of charge that must be injected onto the sense line 16 to reestablish or regain balance of charge on the sense line.

The system above is utilized to determine the position of a finger on or in proximity to a touchpad 10 as follows. This example describes row electrodes 12, and is repeated in the same manner for the column electrodes 14. The values obtained from the row and column electrode measurements determine an intersection which is the centroid of the pointing object on or in proximity to the touchpad 10.

In the first step, a first set of row electrodes 12 are driven with a first signal from P, N generator 22, and a different but adjacent second set of row electrodes are driven with a second signal from the P, N generator. The touchpad circuitry 20 obtains a value from the sense line 16 using a mutual capacitance measuring device 26 that indicates which row electrode is closest to the pointing object. However, the touchpad circuitry 20 under the control of some microcontroller 28 cannot yet determine on which side of the row electrode the pointing object is located, nor can the touchpad circuitry 20 determine just how far the pointing object is located away from the electrode. Thus, the system shifts by one electrode the group of electrodes 12 to be driven. In other words, the electrode on one side of the group is added, while the electrode on the opposite side of the group is no longer driven. The new group is then driven by the P, N generator 22 and a second measurement of the sense line 16 is taken.

From these two measurements, it is possible to determine on which side of the row electrode the pointing object is located, and how far away. Using an equation that compares the magnitude of the two signals measured then performs pointing object position determination.

The sensitivity or resolution of the CIRQUE® Corporation touchpad is much higher than the 16 by 12 grid of row and column electrodes implies. The resolution is typically on the order of 960 counts per inch, or greater. The exact resolution is determined by the sensitivity of the components, the spacing between the electrodes 12, 14 on the same rows and columns, and other factors that are not material to the present invention. The process above is repeated for the Y or column electrodes 14 using a P, N generator 24

Although the CIRQUE® touchpad described above uses a grid of X and Y electrodes 12, 14 and a separate and single sense electrode 16, the sense electrode can actually be the X or Y electrodes 12, 14 by using multiplexing.

A touch sensor using the above or other sensing technology may detect and track the movement of at least two fingers that are in contact with a surface. It would be an advantage over the prior art to provide new and intuitive functions to a touch sensor that have previously only been provided by other input devices such as a computer mouse.

### BRIEF SUMMARY OF THE INVENTION

In a first embodiment, the present invention is a system and method for providing control of an object within a multi-dimensional environment that is being shown on a computer display, wherein two objects such as fingers define two points of contact on a touch sensor, a line being defined between the two points, a center point on the line between the two fingers being calculated and defined as a pivot point, and a perpendicular bisector of the line and that passes through the pivot point may be used to define a forward facing direction of an object within the multi-dimensional environment that is shown on the display screen, wherein the pivot point may be defined as being at a center or at a front facing point of the object.

In a first aspect of the invention, the forward facing direction of the perpendicular bisector may be determined when the two fingers make contact with the touch sensor.

These and other objects, features, advantages and alternative aspects of the present invention will become apparent to those skilled in the art from a consideration of the following detailed description taken in combination with the accompanying drawings.

### BRIEF DESCRIPTION OF THE SEVERAL VIEWS OF THE DRAWINGS

FIG. 1 is a block diagram of the components of a capacitance-sensitive touchpad as made by CIRQUE® Corporation and which may be used to detect a multi-finger gesture in accordance with the principles of the present invention.

FIG. 2 is a top view of a touch sensor 30 showing a first pointing object and a second pointing object to make contact.

FIG. 3 illustrates a two dimensional space that is shown on a display screen.

FIG. 4A is a top view of a touch sensor showing a connecting line, a perpendicular bisector line and a pivot point before a change in location of a finger.

FIG. 4B is a top view of a touch sensor showing the change in the locations of the connecting line, the perpendicular bisector line and the pivot point.

FIG. 4C is a top view in a two or three dimensional space showing that the object has remained in the same place but is now facing a different direction.

FIG. 5A is a top view of a touch sensor showing a connecting line, a perpendicular bisector line and a pivot point before a change in location of two fingers.

FIG. 5B is a top view in a two or three dimensional space showing that the object has remained in the same place but is now facing a different direction.

FIG. 6A is a top view of a touch sensor that shows that any time movement of the two fingers in the same direction causes the object 46 to move translationally within its environment.

FIG. 6B is a top view in a two or three dimensional space showing that the object has moved when the two fingers move together.

FIG. 7 is a top view of a touch sensor that shows that the first two fingers only control the direction of movement, and a third finger 50 is now controlling movement and speed.

FIG. 8 is a top view of a touch sensor that shows that a fourth finger is added to control another function.

FIG. 9 is a top view of a touch sensor that shows that the direction of the perpendicular bisector line may be determined by which of the fingers makes touchdown on the touch sensor first.

FIG. 10 is a top view of a touch sensor that shows that the direction that the perpendicular bisector line is pointing if the first finger to be placed on the touch sensor is reversed relative to the fingers in FIG. 9.

FIG. 11 is a top view of a touch sensor that shows that shows that movement in a forward or backward direction may now include simultaneous movement from side to side as controlled by the third finger.

FIG. 12 is a profile view of a token that may take the place of the first two fingers used to control pivoting of a point of view.

FIG. 13 is a bottom view of the token shown in FIG. 12.

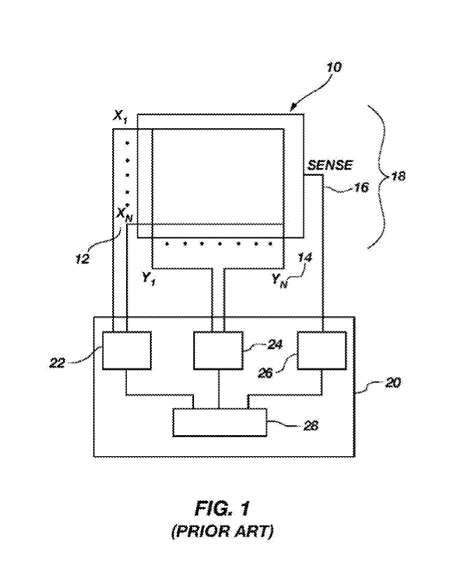

### DETAILED DESCRIPTION OF THE INVENTION

Reference will now be made to the drawings in which the various elements of the present invention will be given numerical designations and in which the invention will be discussed so as to enable one skilled in the art to make and use the invention. It is to be understood that the following description is only exemplary of the principles of the present invention, and should not be viewed as narrowing the claims which follow.

It should be understood that use of the term “touch sensor” throughout this document may be used interchangeably with “proximity sensor”, “touch sensor”, “touch and proximity sensor”, “touch panel”, “touchpad” and “touch screen”. Furthermore, all references to contact with a surface of a touch sensor may be used interchangeably with a virtual surface.

A first embodiment of the present invention is directed to a multi-finger gesture on a touch sensor and may be demonstrated using an illustration of a touch sensor.

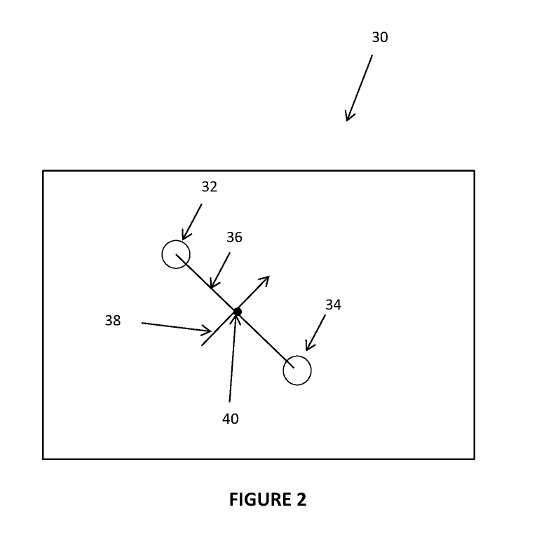

FIG. 2 is a top view of a touch sensor 30 of the first embodiment showing a first pointing object (first object to make contact) and a second pointing object 34 (second object to make contact). The pointing objects may be fingers or a thumb and a finger of a hand, and will be referred to as fingers. Two fingers 32, 34 are shown spaced apart some arbitrary distance. The fingers 32, 34 may be spaced apart some measurable distance so that a connecting line 36 may be defined as being disposed between a center of the first finger (to make contact) 32 and a center of the second finger (to make contact) 34. The connecting line 36 may be bisected by a perpendicular line 38 at a midpoint of the line that is equidistant between the two fingers 32, 34. The perpendicular bisector line 38 thus may bisect the connecting line 36 at a midpoint of the connecting line 36.

The midpoint of the connecting line 36 may also be referred to as a pivot point 40. It should be understood that as one or both of the fingers 32, 34 are moved along the surface of the touch sensor 30, the length of the connecting line 36 may change. Nevertheless, the pivot point 40 may be continuously adjusted to be the midpoint of the connecting line 36. The pivot point 40 may therefore be adjusted on-the-fly so that the pivot point may always be an accurate representation of the midpoint of the connecting line 36.

Similarly, the location and the direction of the perpendicular bisector line 38 may also be continuously updated as one or more of the positions of the two fingers 32, 34 are changing.

It should be understood that if the two fingers 32, 34 make contact with the touch sensor at essentially the same time, that one of the fingers may be arbitrarily assigned to be the first finger to make contact.

The purpose of the multi-finger gesture may be to obtain the location of the pivot point 40 and the perpendicular bisector line 38 that passes through the pivot point. It should be understood that the pivot point 40 and the perpendicular bisector line 38 may be obtained for any two points that may be detected on the touch sensor 30. Accordingly, while the touch sensor 30 described above is a capacitance sensitive touch sensor as known to those skilled in the art, any technology may be used to detect the location of two objects relative to each other, define a connecting line between the objects, and then define a perpendicular bisector of a midpoint of the connecting line.

In this first embodiment, the touch sensor is using capacitance sensing. However, the touch sensor may use any technology that can identify the location of two objects on a surface. Such technology may include but should not be considered as limited to pressure sensing, infra-red sensing and optical sensing.

Application of the multi-finger gesture may provide new functionality to the touch sensor 30. For example, the multi-finger gesture may be used to control the motion of an object that exists within a multi-dimensional environment that is shown on a display screen.

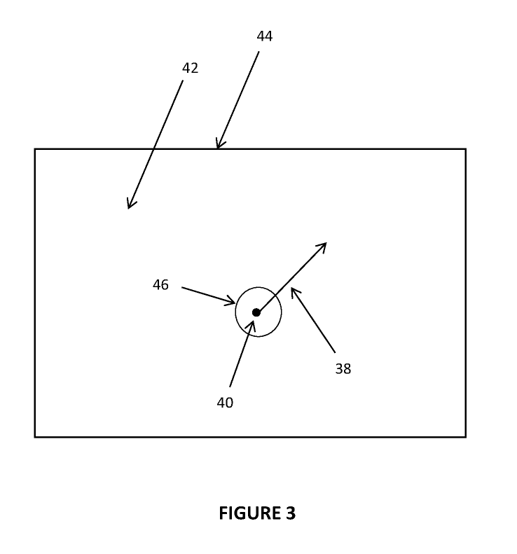

FIG. 3 illustrates a two dimensional space 42 that is shown on a display screen 44. An object 46 that exists within the two dimensional space may be shown by displaying a top view of the two dimensional space 42 and the object 46 in that space. The two dimensional space 42 shown may only be a portion of that space or all of that space that is shown on the display. The object 46 may be shown as a circle but it may also have any desired shape and is not limited to a circle. The pivot point 40 may be used to represent some point on or within the object 46. For example, the pivot point 40 may be located at a center of the object 46. However, the pivot point 40 may also be located at any other location such as at a location designated to be the “front” or “face” of the object 46.

The perpendicular bisector line 38 is shown extending from the pivot point 40 of the object 46. The direction that the perpendicular bisector line 38 is pointing may be used to indicate a direction that the object 46 is facing or pointing. Having a direction of the object 46 may be useful if the object is to be moved or rotated within the two dimensional space 42.

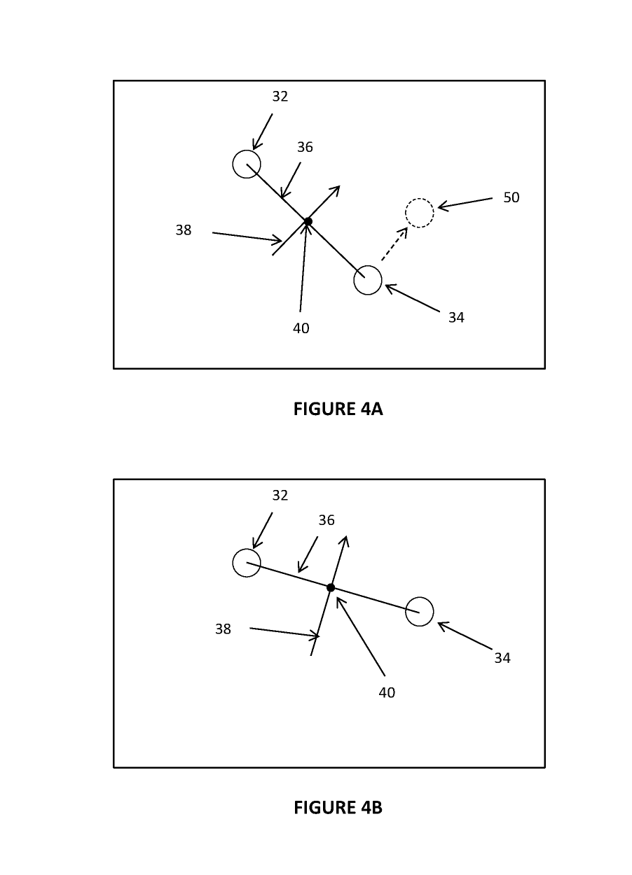

A first action that will be demonstrated is a pivoting action shown in FIG. 4A. Therefore, if the object 46 is to pivot around the pivot point 40 to the left but not move translationally, the first finger 32 may remain stationary, while the second finger 34 may be moved from an original location to a new location 50 as indicated by the dotted arrow and circle.

FIG. 4B shows the change in the locations of the connecting line 36, the perpendicular bisector line 38 and the pivot point 40. Because the first finger 32 remained stationary, the object 46 may not move but instead may only rotate. This is shown in FIG. 4C.

FIG. 4C shows that the object 46 has remained in the same location but is now facing a different direction as indicated by the dotted arrow showing the rotation of the perpendicular bisector line 38 around the pivot point 40. The perpendicular bisector line 38 has pivoted in a counter clockwise direction.

Some observations of the first embodiment include that the length of the connecting line 36 may have changed without affecting the rotation of the perpendicular bisector line 38 in FIG. 4C. The rotation of the perpendicular bisector line 38 may only be affected by the change in position of the second finger 34 causing a change in the location of the connecting line 36 and an associated change in the direction of the perpendicular bisector line 38.

If the second finger 34 remains stationary and the first finger 32 were to be moved toward a top edge of the touch sensor 30, the perpendicular bisector line 38 may pivot clockwise back towards its original position shown in FIG. 3. However, if the first finger 32 were to be moved toward a bottom edge of the touch sensor 30, then the perpendicular bisector line 38 may rotate in a counter clockwise direction.

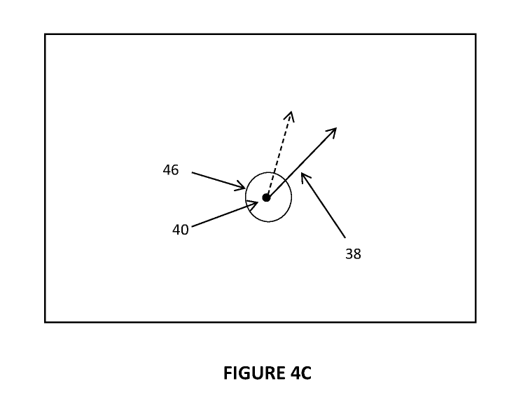

Another way to pivot the perpendicular bisector line 38 is to move both the first finger 32 and the second finger 34 at the same time. As shown in FIG. 5A, if the first finger 32 moves in the direction indicated and the second finger moves in the direction indicated, then perpendicular bisector line 38 may pivot as shown in FIG. 5B. Because the first finger 32 and the second finger 34 are now on a same horizontal position relative to each other, the perpendicular bisector line 38 would be vertical as shown in FIG. 5B.

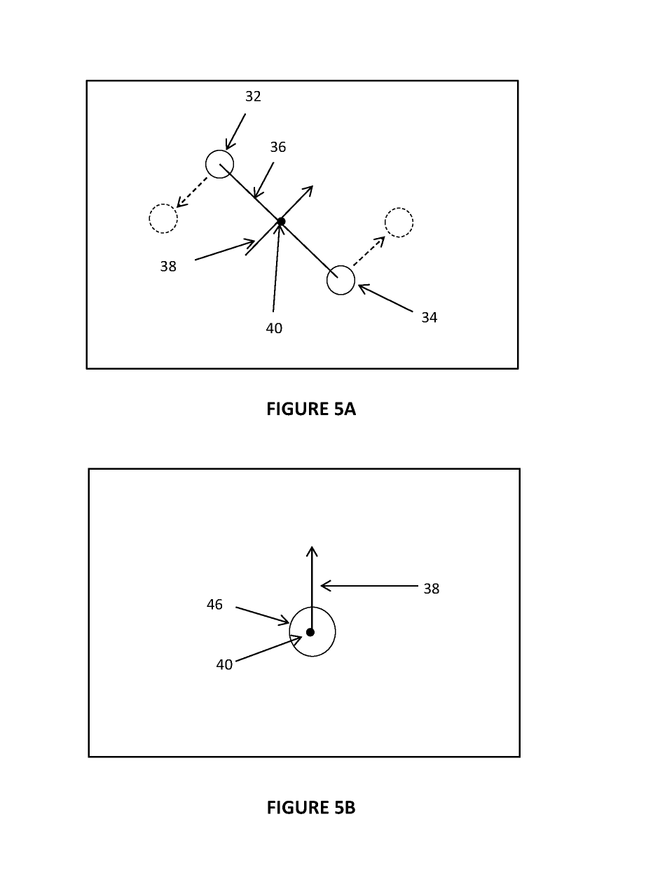

FIGS. 5A and 5B show what happens when the two fingers 32, 34 move in directions that are opposite to each other. In the first embodiment, a different action may occur and a different movement may happen to the object 46 when the fingers 32, 34 are moved in a same direction as indicated by the dotted lines in FIG. 6A.

FIG. 6A shows that in this first embodiment, depending upon the characteristics of the two dimensional space 42 in which the object 46 is located, we may assume for this example that any time movement of the two fingers 32, 34 is in the same direction, the object 46 may be caused to move translationally within its environment.

FIG. 6B shows that the object 46 may continue to face the direction of the perpendicular bisector line 38 while moving at the angle and direction indicated by the dotted arrow.

The touch sensor 30 is a finite shape so the fingers 32, 34 cannot continue to move but must stop before the first finger 32 reaches the edge of the touch sensor 30. However, for this example of the first embodiment, the translational movement of the object 46 within the two dimensional space 42 may continue until the fingers 32, 34 are moved again. This movement of the fingers 32, 34 may cause the object 46 to stop, pivot or move in a different direction as controlled by the simultaneous and same direction movement of the fingers 32, 34.

The fingers 32, 34 may move in more than just one direction in a coordinated motion. For example, the fingers may move in a curvilinear path, stopping at times and beginning motion again, all the while controlling the movement of the object 46 within the two dimensional space 42. The object 46 may be caused to only pivot, only move translationally, or both pivot and move translationally at the same time by making the associated motions with the two fingers 32, 34.

One particularly useful application of the control of the object 46 described in the first embodiment is in the manipulation of an object in two or three dimensional space. For example, a computer aided design (CAD) program may use the control taught in the first embodiment to manipulate an object or objects being drawn or examined in two or three dimensional space.

Another application of the first embodiment is the control of an object in a gaming environment. For example, an avatar or three dimensional character may be disposed within a three dimensional gaming environment. Control of the character's movement may be accomplished using the first embodiment of the invention. For example, the object being controlled may be a character. If the gaming environment is three dimensional, then the object may be the character, where the pivot point may be a central axis of the character, and the direction of the perpendicular bisector line may be a direction that the character is facing.

The first embodiment may provide the ability for the character to rotate and to move. However, in a second embodiment of the invention, more than two fingers may be used on the touch sensor 30 in order to provide additional capabilities or functionality.

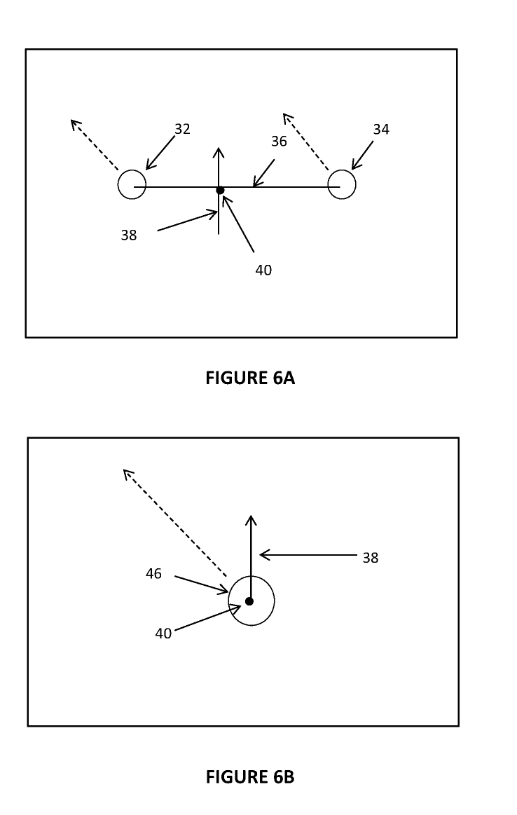

In the example of the three dimensional gaming environment, the first two fingers may be assigned the task of controlling the direction that an object is facing within the three dimensional environment. FIG. 7 shows that the fingers 32, 34 of the second embodiment are different from the first embodiment by only controlling the direction of movement, but not the movement itself. Instead, a third finger 50 is now placed on the touch sensor 30 and dedicated to controlling movement and speed. For example, if a third finger 50 makes touchdown at the location show, this location now serves as the location from where movement is controlled.

Movement of the third finger 50 may control movement by selecting a direction that will cause forward movement and an opposite direction to cause backwards movement. Speed is controlled by the distance that the third finger 50 is moved away from the location that touchdown occurred.

For example, if the third finger 50 is moved in the direction of arrow 54, then the character may arbitrarily be assigned the attribute of moving in a forward direction based on the direction that the perpendicular bisector line 38 is pointing in the three dimensional environment. The further that the third finger 50 is moved from the location that touchdown occurred, the faster the character may be caused to move. If the third finger 50 is near the top of the touch sensor 30 and the third finger then reverses course and starts to move backwards towards the location where touchdown occurred, the character does not move backwards but slows down forward movement until the location of touchdown is reached. If the third finger 50 continues to move in the direction of arrow 56 and the original location of touchdown is passed, then movement of the character may be backwards. Speed may still be controlled by the distance that the third finger 50 moves away from the original touchdown location.

Touchdown of the third finger 50 can be anywhere on the touch sensor 30. However, in order to maximize the amount of movement of the third finger 50 in order to control the speed of the character, the original touchdown location should ideally be halfway between a top edge and the bottom edge of the touch sensor 30.

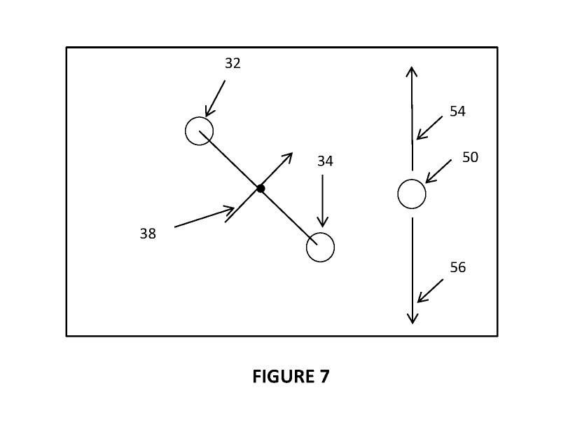

FIG. 8 shows that in the second embodiment, a fourth finger 58 may be also be used to provide additional functionality. For example, in a gaming environment, touchdown of the fourth finger 58 may trigger a gun to fire, a different movement to occur such as jumping or crouching, or any other function that may be required in the game.

Accordingly, it should be apparent that all of the embodiments of the present invention enable multiple fingers to perform different functions simultaneously on the touch sensor 30. However, controlling the direction that a character is facing may require that the first finger 32 and the second finger 34 be disposed on the touch sensor 30 before any of the other functions may be activated or controlled by one or more other fingers.

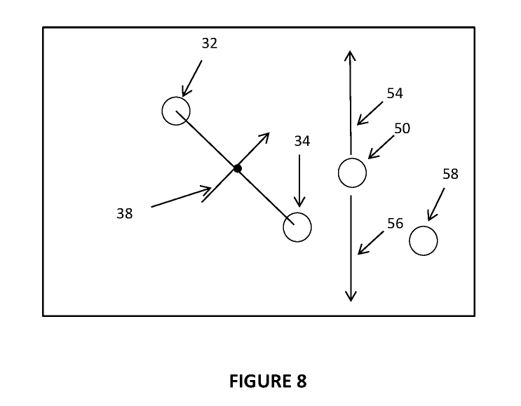

It may not be immediately apparent how the direction that the perpendicular bisector line 38 is determined to be pointing upon touchdown of the fingers 32, 34. FIG. 9 is used to illustrate the concept that in all of the embodiments of the invention, the direction of the perpendicular bisector line 38 may be determined by which of the fingers 32, 34 makes touchdown on the touch sensor 30 first. FIG. 9 shows that the direction that the perpendicular bisector line 38 is pointing may always be to the left of the connecting line 36 from the perspective of moving from the first finger 32 towards the second finger 34. Thus in FIG. 9, when moving from the first finger 32 towards the second finger 34, the perpendicular bisector line 38 is pointing towards a top edge of the touch sensor 30.

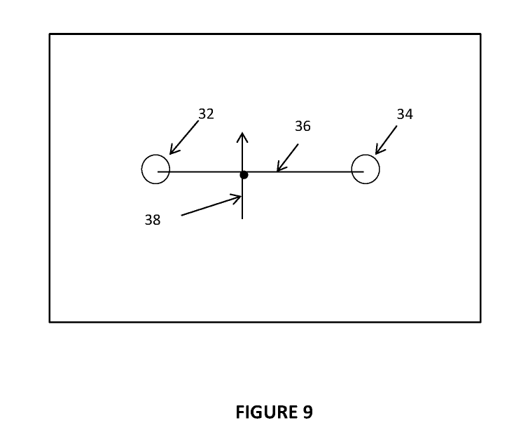

In contrast, FIG. 10 shows the direction that the perpendicular bisector line 38 is pointing if the first finger 32 to be placed on the touch sensor 30 is reversed relative to the fingers 32, 34 in FIG. 9. Thus, when moving from the first finger 32 in FIG. 10 towards the second finger 34, the perpendicular bisector line 38 is now pointing towards a bottom edge of the touch sensor 30. It should be understood that this orientation of the perpendicular bisector line 38 may be consistent no matter where the first finger 32 and the second finger 34 are located relative to each other. The direction of the perpendicular bisector line 38 may always be pointing to the left of the connecting line 36 when moving from the first finger 32 towards the second finger 34.

While the embodiments above may have chosen a convention of determining the direction of the perpendicular bisector line 38 by moving from the first finger 32 towards the second finger 34 and then pointing towards the left of the connecting line 36, this selection is arbitrary. Accordingly, in another embodiment of the invention, the perpendicular bisector line 38 may always point to the right of the connecting line 36 when moving from the first finger 32 towards the second finger 34.

It is unlikely that the fingers 32, 34 will make touchdown simultaneously. However, the embodiments of the invention may use any suitable means to determine which finger should be considered to make touchdown first. For example, the system may randomly select either finger to be the first finger 32, or the finger on the right or the left side of the touch sensor 30 may always be selected as being the first finger 32.

The prior art may teach avoiding the use of a touch sensor 30 for playing games in two or three dimensional environments because of the difficulty of controlling movement of a character and performing additional functions. This difficulty may be because movement and other functions may have required the use of a mouse click or click and hold. Furthermore, some modern touch sensors may not have physical mouse buttons but instead use a single mechanical button under the touch sensor to perform a mouse click. Some touch sensors may only allow one type of mouse click, such as a left or right mouse click. Some other touch sensors may only allow one type of mouse click at a time. The embodiments of the present invention may be used with any type of touch sensor, regardless of the availability of right or left mouse clicks because no mouse clicks may be required in order to perform all of the movement control and other functions of the game.

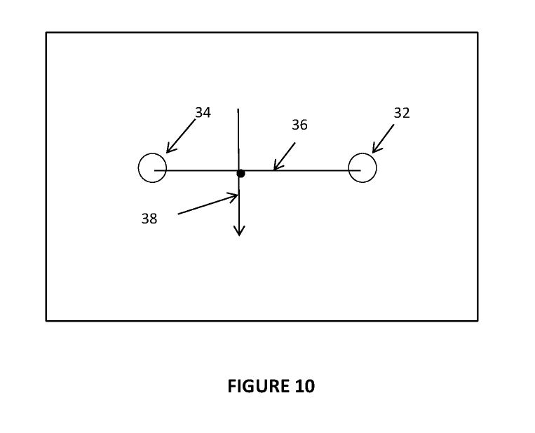

FIG. 11 is provided to illustrate another feature of some embodiments of the invention. In the second embodiment as illustrated by FIGS. 7 and 8, when movement of a character is controlled by a third finger 50, only forward or backward movement was possible. The direction of movement using the fingers 32, 34 in order to change a direction of movement.

However, in this third embodiment of the invention shown in FIG. 11, it may now be possible to add a sideways moving component to a forward and backward direction of travel. FIG. 11 shows that the third finger 50 has made touchdown. A circle 60 is now disposed conceptually around the third finger 50. This circle 60 illustrates the concept that movement anywhere in the top half of the circle and above line 62 will cause forward movement and may simultaneously add a sideways motion. Circle 60 actually represents a static movement and speed controller. What is meant by static is that the directions of moving forward are always those above line 62, but relative to whatever direction the perpendicular bisection line 38 is pointing.

For example, assume that the third finger 50 is moved to some position along arrow 64. An object in a two or three dimensional environment that is being controlled by the fingers 32, 34 and 50 would not only move in a forward direction but may also have a sideways movement component. Because the arrow 64 is at approximately a 45 degree angle with respect to the line 62, the movement of the object would be at approximately a 45 degree angle relative to a direction that the object was facing. There would be equal amount of forward movement and sideways movement to the right from the perspective of the character.

Arrow 66 is below line 62 and therefore would result in movement of the character that is partly backwards and also to the right. Because the arrow 66 is closer to the line 62, the movement will be more to the right and only slight backwards. It is important to remember that the point of view of the character is not being changed. So the view into the three dimensional world would not be changing because the fingers 32, 34 are not being moved. The character would move slightly backwards and to the right while the object faces in the same direction as it was before movement began.

The point of view controlled by the fingers 32, 34 may be moved at the same time as the character is moving. For example, the character could be caused to move in the direction indicated by the arrow 64 while one or both fingers 32, 34 would move to cause pivoting of the point of view. As stated previously, movement as represented by circle 60 may always be relative to the direction of the perpendicular bisector line 38. In other words, a dashed line representing the perpendicular bisector line 38 is disposed within the circle 60 of FIG. 11 because it would not move.

Accordingly, the third finger 50 may provide movement in any direction as illustrated by the circle 60 around the third finger shown in FIG. 11. The circle 60 represents the complete 360 degrees of motion that a character may experience in the three dimensional environment. Because the third finger 50 is only controlling motion and speed of the character, the point of view is still controlled by the fingers 32, 34.

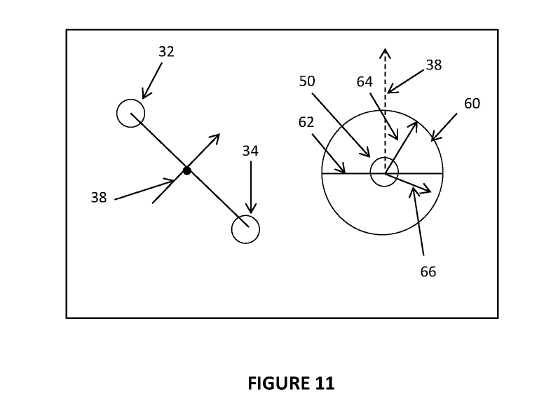

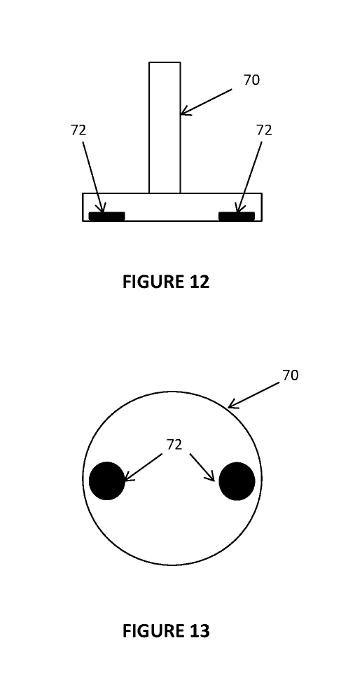

FIG. 12 is provided as a profile view of a token 70. A token 70 may be used by placing it on the touch sensor 30. The token 70 includes two inserts 72 that may be used in place of fingers 32, 34. The inserts 72 may be detected by the touch sensor 30 and operate as if they were the two fingers 32, 34 that change the point of view of an object in a two or three dimensional environment. By placing the token 70 on the touch sensor 30, fingers do not have to be used to change the point of view of a character. Instead the token 70 may just be turned to cause the point of view to change. FIG. 13 shows a bottom view of the token 70.

In another aspect of the invention, the spacing of the inserts 72 in the token 70 may have significance. For example, the spacing may be unique for each character or playing piece within a game. Thus, when a user places the token 70 on the touch sensor, the user may be providing an identification of the character as well as the ability to pivot the character by just twisting the token. A different or third finger may then be used to control movement and the speed of movement of the character, even though it is actually the first finger to be placed in the touch sensor 30. The token 70 takes the place of the first finger 32 and the second finger 34.

In an alternative embodiment, other inserts 72 that may be detectable by the touch sensor 30 may be added to the token 70. The purpose of the other inserts 72 may be to perform other functions such as providing other identifying information. For example, the distance between the inserts 72 may serve as an identity of the token.

Although only a few example embodiments have been described in detail above, those skilled in the art will readily appreciate that many modifications are possible in the example embodiments without materially departing from this invention. Accordingly, all such modifications are intended to be included within the scope of this disclosure as defined in the following claims. It is the express intention of the applicant not to invoke 35 U.S.C. §112, paragraph 6 for any limitations of any of the claims herein, except for those in which the claim expressly uses the words ‘means for’ together with an associated function.

What is claimed is:

1. A method for controlling a point of view within a three dimensional environment, said method comprising:
providing a touch sensor, a three dimensional environment, an object disposed within the three dimensional environment, and a display screen that shows a point of view of the three dimensional environment from the perspective of the object;
detecting a first object on the touch sensor;
detecting a second object on the touch sensor;
determining a location of a connecting line between the first object and the second object;
determining a midpoint between the first object and the second object on the connecting line;
determining the location of a perpendicular bisector line of the connecting line and through the midpoint;
assigning a direction of the perpendicular bisector line to be pointing to the left of the connecting line as viewed from the position of the first object and moving towards the second object; and
assigning the direction of the perpendicular bisector line to be the point of view of the object.

2. The method as defined in claim 1 wherein the method further comprises moving either the first finger or the second finger to cause the point of view to change relative to a change in direction of the perpendicular bisector line as it pivots around the midpoint of the center line as the first finger or the second finger is caused to move.

3. The method as defined in claim 2 wherein the method further comprises using a third finger to control movement and speed of movement within the three dimensional environment.

4. The method as defined in claim 3 wherein the method further comprises enabling simultaneous sideways movement along with either forward or backward movement.

5. The method as defined in claim 2 wherein the method further comprises using a fourth finger to control a different function within the three dimensional environment.

6. The method as defined in claim 2 wherein the method further comprises moving the first finger and the second finger in a substantially same direction in order to cause translational movement of the object within the three dimensional environment.

7. The method as defined in claim 2 wherein the method further comprises using a third finger to control movement and speed of movement within the three dimensional environment, wherein movement is restricted to a forward or backward direction.

8. The method as defined in claim 1 wherein the object is a character in the three dimensional environment.

9. A method for controlling a point of view within a three dimensional environment, said method comprising:
providing a touch sensor, a three dimensional environment, an object disposed within the three dimensional environment, and a display screen that shows a point of view of the three dimensional environment from the perspective of the object;
making contact on the touch sensor with the first object and the second object;
determining a midpoint between the first object and the second object;
determining the location of a perpendicular bisector line through the midpoint that is perpendicular to a line between the first object and the second object;
assigning a direction of the perpendicular bisector line to be pointing to the left of the line as viewed from the position of the first object and moving towards the second object; and
assigning the direction of the perpendicular bisector line to be the point of view of the object.

10. A method for controlling a point of view within a three dimensional environment, said method comprising:
providing a touch sensor, a three dimensional environment, an object disposed within the three dimensional environment, and a display screen that shows a point of view of the three dimensional environment from the perspective of the object;
providing a token having a first insert and a second insert on a bottom surface thereof, wherein the first insert and the second insert are detectable by the touch sensor;
making contact on the touch sensor with the first insert and the second insert by placing the token on the touch sensor;
determining a midpoint between the first insert and the second insert;
determining the location of a perpendicular bisector line through the midpoint that is perpendicular to a line between the first insert and the second insert;
assigning a direction of the perpendicular bisector line to be pointing to the left of the line as viewed from the position of the first insert and moving towards the second insert; and
assigning the direction of the perpendicular bisector line to be the point of view of the object.

11. The method as defined in claim 11 wherein the method further comprises providing one or more additional inserts in the token that are detectable by the touch sensor.
